(19) United States
(12) Patent Application Publication
(10) Pub. No.: US 2005/0245158 A1
(43) Pub. Date: Nov. 3, 2005

(54) Multicomponent fibers and nonwoven fabrics and surge management layers containing multicomponent fibers

(75) Inventors: Ali Yahiaoui, Roswell, GA (US); Eric Scott Kepner, Alpharetta, GA (US); Roger Bradshaw Quincy III, Cumming, GA (US); Roland Columbus Smith JR., Gainesville, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/835,835

(22) Filed: Apr. 30, 2004

(51) Int. Cl. B32B 27/12; D03D 15/00; B32B 5/02; B32B 27/04; D04H 1/00; D04H 5/00; D04H 3/00; B32B 5/26; D04H 13/00

(52) U.S. Cl. 442/118; 442/361; 442/362; 442/382

(57) ABSTRACT

The present invention provides multicomponent fibers, nonwoven fabrics and surge management layers that include multicomponent fibers that comprise a first component that comprises a blend of a first polyolefin and from about 0.1 to about 5 weight percent of an ethoxylated hydrocarbon and a second component that comprises a blend of a second polyolefin and from about 0.1 to about 5 weight percent of an ethoxylated siloxane.

### BACKGROUND OF THE INVENTION

The present invention relates to nonwoven fabrics, particularly to wettable bicomponent nonwoven fabrics and to methods for forming wettable bicomponent nonwoven fabrics. Generally, nonwoven fabrics produced from polyolefin resins are not wetted by bodily fluids, such as urine and menses. Polyolefin-based nonwoven fabrics have been topically treated with aqueous surfactants and have been treated with internal melt additives so that the polyolefin nonwoven fabrics are more wettable and can be used as components in disposable personal care absorbent products, for example diapers. A surge management layer is designed to quickly absorb and temporarily hold large amounts of fluid, such as an insult of urine.

While various methods are known in the art for improving or modifying the surface characteristics of polymeric fibers, there remains a continuing need for providing fabrics with the desired physical properties that can be made more efficiently and/or economically. This is particularly true where the products are intended to be used as or within disposal articles such as, for example, wipes, sorbents, medical fabrics, personal care products and so forth. It would be desirable to provide wettable fabrics that do not require the addition of aqueous chemistries to the fabrics and improved method of making such fabrics that do not require treating the fabrics after the fabrics are formed. In addition, it would be desirable to provide fabrics that maintain their wettability after multiple insults and, thus, have durable wettability.

### SUMMARY

The present invention provides multicomponent fibers, desirably bicomponent fibers and even more desirably side by side bicomponent fibers that include at least one first component that includes a blend of a first polyolefin and from about 0.1 to about 5 weight percent of an ethoxylated hydrocarbon and a second component that comprises a blend of a second polyolefin and from about 0.1 to about 5 weight percent of an ethoxylated siloxane, wherein the first component and the second component each independently form at least a portion of the exterior surface of the multicomponent fiber. In one suggested embodiment, the ethoxylated siloxane is or includes poly[dimethylsiloxane-co-methyl(3-hydroxypropyl)siloxane]-graft-poly(ethylene glycol) methyl ether and the ethoxylated hydrocarbon is or comprises poly(ethylene glycol) 600 dioleate. Desirably, the first polyolefin and the second polyolefin are selected from the group consisting of homopolymers and copolymers of ethylene and homopolymers and copolymers of propylene. More desirably, the first polyolefin is selected from the group consisting of homopolymers and copolymer of ethylene and the second polyolefin is selected from the group consisting of homopolymers and copolymers of propylene. In one desirable embodiment, the first component includes from about 0.5 to about 3 weight percent of the ethoxylated hydrocarbon and the second component includes from about 0.5 to about 3 weight percent of the ethoxylated siloxane.

The present invention also provides nonwoven fabrics, for example spunbonded or meltblown fabrics that are formed from such multicomponent fibers. For example, the present invention provides a nonwoven fabric that includes or consists of multicomponent fibers that include a first component that includes a blend of a first polymer and from about 0.1 to about 5 weight percent of an ethoxylated hydrocarbon surfactant and a second polymer that includes a blend of a second polyolefin and from about 0.1 to about 5 weight percent of an ethoxylated siloxane surfactant. Desirably, the first component is a substantially homogeneous melt blend that includes the first polymer and the ethoxylated hydrocarbon surfactant and the second component is a substantially homogeneous melt blend that includes the second polymer and the ethoxylated hydrocarbon surfactant. Suggested polymers include polyolefins, particularly homopolymers and copolymers of ethylene and homopolymers and copolymers of propylene. In one embodiment, the first component and the second component are arranged in substantially distinct zones across the fiber cross-section and extend substantially continuously along the length of the fibers so that the first component and the second component each have exposed portions forming the outer surface of the multicomponent fibers and each component forms at least about 25 percent of the outer surface of the multicomponent fibers, more desirably at least about 33 percent of the outer surface and even more desirable at least about 40 percent of the outer surface.

The present invention also provides surge management layers adapted for use in disposable personal care absorbent products such as diapers, training pants and so forth, the surge management layer that is or otherwise includes a spunbonded nonwoven fabric or a meltblown nonwoven fabric, wherein the nonwoven fabric includes bicomponent fibers that include a first component that is or includes a blend comprising from about 80 to about 99.9 weight percent of a polyethylene resin and from about 0.1 to about 5 weight percent of an ethoxylated hydrocarbon and a second component that comprises a blend comprising from about 80 to about 99.9 weight percent of a polypropylene resin and from about 0.1 to about 5 weight percent of an ethoxylated siloxane, wherein the first component and the second component form at least a portion of the exterior of the fibers and are in a side by side configuration.

The present invention also provides surge management layer and liners adapted for use in a disposable personal care absorbent product, wherein the surge management layer or liner is or otherwise includes a spunbond nonwoven fabric that includes a first level of bicomponent fibers that include a first component that is or includes a blend comprising from about 80 to about 99.9 weight percent of a polyethylene resin and from about 0.1 to about 5 weight percent of an ethoxylated hydrocarbon or a derivative thereof, an ethoxylated siloxane or a derivative thereof or a combination thereof and a second component that includes a blend comprising from about 80 to about 99.9 weight percent of a polypropylene resin and from about 0.1 to about 5 weight percent of an ethoxylated hydrocarbon or a derivative thereof, an ethoxylated siloxane or a derivative thereof or a combination thereof, wherein the first component and the second component are in a side-by-side configuration.

In yet another embodiment, the present invention provides fibers, a nonwoven fabric and personal care products that include fibers or a nonwoven fabric that has a first wettability at 35° C. and a second wettability at 21° C. such that the second wettability is slower than the first wettability. For example, the fibers and the nonwoven fabric of at least one embodiment can wet out in less than about 10 seconds at 35° C. but do not wet out in less than about 60 seconds at 21° C. In one example, the nonwoven fabric comprises bicomponent fibers that include a first component that includes a blend comprising from about 80 to about 99.9 weight percent of a polyethylene resin and from about 0.1 to about 5 weight percent of an ethoxylated hydrocarbon and a second component that includes a blend that includes from about 80 to about 99.9 weight percent of a polypropylene resin and from about 0.1 to about 5 weight percent of an ethoxylated hydrocarbon.

### BRIEF DESCRIPTION OF THE DRAWINGS

FIG. 1 illustrates a process and apparatus for producing a lofty, nonwoven material in accordance with one embodiment of this invention.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

Definitions

As used herein, the term “nonwoven web” or “nonwoven material” means a web having a structure of individual fibers, filaments or threads which are interlaid, but not in a regular or identifiable manner such as those in a knitted fabric and includes films that have been fibrillated. Nonwoven webs or materials have been formed from many processes such as, for example, meltblowing processes, spunbonding processes, and bonded carded web processes. The basis weight of nonwoven webs or materials is usually expressed in ounces of material per square yard (osy) or grams per square meter (gsm), and the fiber diameters are usually expressed in microns. Another frequently used expression of fiber diameter is denier, which is defined as grams per 9000 meters of a fiber and may be calculated as fiber diameter in microns (μm) squared, multiplied by the polymer density in grams/cc, multiplied by 0.00707. A lower denier indicates a finer fiber and a higher denier indicates a thicker or heavier fiber. For example, the diameter of a polypropylene fiber given as 15 microns (μm) may be converted to denier by squaring, multiplying the result by 0.89 g/cc and multiplying by 0.00707. Thus, a 15 micron (μm) polypropylene fiber has a denier of about 1.42 (152×0.89×0.00707=1.415). Outside the United States the unit of measurement is more commonly the “tex”, which is defined as the grams per kilometer of fiber. Tex may be calculated as denier/9. (Note that to convert from osy to gsm, multiply osy by 33.91.)

As used herein, the term “z-direction” refers to fibers disposed outside of the plane of orientation of a web. A web will be considered to have an x-axis in the machine direction, a y-axis in the cross machine direction and a z-axis in the loft direction, with the web's major planes, or surfaces, lying parallel with the x,y-plane. The term “as formed z-direction fibers” may be used herein to refer to fibers that become oriented in the z-direction during forming of the nonwoven web as distinguished from fibers having a z-direction component resulting from post-forming processing of the nonwoven web, such as in the case of mechanically crimped or creped or otherwise disrupted nonwoven webs.

As used herein, the term “wetting agent” refers to any chemical, compound or composition that makes a fiber surface exhibit increased hydrophilic characteristics such as by lowering the contact angle of an aqueous fluid that comes in contact with the fiber surface and/or by lowering the surface tension of aqueous fluid(s) that come in contact with the fiber surface.

As used herein, the term “internal treatment” refers to an any chemical, compound or composition that is added internally to a polymer, for example by blending or extruding with a melted polymer, to form a composition that includes the polymer and the additive.

“Integrally bonded” as used herein refers to the bonding of a layer of material without adhering the subject web to additional webs.

“Low machine direction orientation” and “high machine direction orientation” as used herein refers to the degree to which the fibers of a nonwoven web are allowed to disperse over the cross direction of the forming surface, e.g. a foraminous wire. Low machine direction orientation fibers are arranged with the longer axis pointing in the cross direction to a higher degree than a collection of fibers exhibiting a higher machine direction orientation which have less orientation in the cross direction of the forming surface during the formation of a web.

As used herein, the term “substantially continuous fibers” refers to fibers which are not cut from their original length prior to being formed into a nonwoven web or fabric. Substantially continuous fibers may have average lengths ranging from greater than about 15 centimeters to more than one meter, and up to the length of the web or fabric being formed. The definition of “substantially continuous fibers” includes fibers which are not cut prior to being formed into a nonwoven web or fabric, but which are later cut when the nonwoven web or fabric is cut, and fibers which are substantially linear or crimped.

As used herein, the term “through-air bonding” or “TAB” refers to any process of integrally bonding a nonwoven by adhering the fibers of the web to each other, for example a bicomponent fiber web, in which air which is sufficiently hot to melt one of the polymers of which the fibers of the web are made is forced through the web.

As used herein “side by side fibers” belong to the class of bicomponent or conjugate fibers. The term “bicomponent fibers” refers to fibers which have been formed from at least two polymer components extruded from separate extruders but spun together to form one fiber. Bicomponent fibers are also sometimes referred to as conjugate fibers or multicomponent fibers. Bicomponent fibers are taught, e.g., by U.S. Pat. No. 5,382,400 to Pike et al. which is incorporated by reference in its entirety. The polymers of conjugate fibers are usually different from each other though some conjugate fibers may be monocomponent fibers. Conjugate fibers are taught in U.S. Pat. No. 5,108,820 to Kaneko et al., U.S. Pat. No. 4,795,668 to Krueger et al. and U.S. Pat. No. 5,336,552 to Strack et al. all of which are incorporated by reference in their entirety. Conjugate fibers may be used to produce crimp in the fibers by using the differential rates of expansion and contraction of the two (or more) polymers.

As used herein, the term “machine direction” or MD means the length of a fabric in the direction in which it is produced. The term “cross machine direction” or CD means the width of fabric, i.e. a direction generally perpendicular to the MD.

As used herein, the term “personal care product” includes products such as, but not limited to, bandages and wound care items, diapers, training pants, swimwear, absorbent underpants, adult incontinence products, feminine hygiene products and mortuary and veterinary products.

Words of degree, such as “about”, “substantially”, and the like are used herein in the sense of “at, or nearly at, when given the manufacturing, design, material and testing tolerances inherent in the stated circumstances” and are used to prevent the unscrupulous infringer from unfairly taking advantage of the invention disclosure where exact or absolute figures are stated as an aid to understanding the invention.

As used herein, all percentages, ratios and proportions are by weight unless otherwise specified.

### DESCRIPTION OF ILLUSTRATED EMBODIMENTS

Generally, the present invention provides fibers and nonwoven fabrics that include at least two components one component of which includes an additive or a combination of additives to improve the wettability of the fibers and/or a fabric. A second component can include another additive or another combination of additives in an amount that can be similar or different from the amount of the additive or the combination of additives in the first or other component of the multicomponent fibers. For example, in one desirable embodiment, a multicomponent fiber that includes a first component that includes a blend of a first polyolefin and a first amount of a first surfactant and a second component that includes a blend of a polyolefin and a second amount of the first surfactant, wherein the second amount of the surfactant differs from the first amount of the surfactant. The second amount of the first surfactant may be zero or essentially zero weight percent of the surfactant relative to the weight of the second component. In exemplary embodiments, the multicomponent fiber is a bicomponent fiber in a side by side configuration. Other bicomponent and multicomponent configurations are possible. However, it is suggested that the first component form at least a portion of the exterior surface of the multicomponent fiber and the second component also form at least a portion of the exterior surface of the multicomponent fiber. When using only two polymer compositions to form the individual components of the multicomponent fibers, the respective polymer components A and B can be present in ratios, by volume or by weight, of from about 90/10 to about 10/90 and desirably range between about 75/25 and about 25/75. Ratios of approximately 50/50 are often particularly desirable however the particular ratios employed can vary as desired.

Multicomponent fibers are well known and include, but are not limited to, bicomponent fibers, tricomponent fibers and so forth. In addition, various configurations of multicomponent fibers are well known and include, but are not limited to, side by side bicomponent fibers, sheath-core fibers including cocentric and eccentric sheath-core fibers, striped fibers, pie-component fibers and so forth. Desirably, the multicomponent fibers should have at least two components that form an exterior surface on the multicomponent fibers. The term multicomponent refers to fibers that have been formed from at least two polymer streams and extruded to form a unitary fiber. The individual components of a multicomponent fiber are arranged in distinct regions in the fiber cross-section, which extend substantially continuously along the length of the fiber. The cross-sectional configuration of the multicomponent fibers has at least two distinct components that comprise a portion of the outer surface of the fiber. The multicomponent fiber can have three, four or more exposed segments forming the outer surface of the fiber. As indicated above, at least two of the segments of the individual polymeric components collectively form the outer surface of the multicomponent fiber.

In one desirable embodiment, the present invention provides multicomponent fibers and nonwoven fabrics of fibers that include a first component that includes at least one additive for improving the wettability of the fiber or fabric wherein the first component of the fiber includes a first additive and a second component that includes a second additive that differs in chemical structure or composition from the first additive. For example, the present invention provides a multicomponent fiber that includes a first component comprising a blend of a first polyolefin and of a first additive and a second component that comprises a blend of a second polyolefin and of a second additive, wherein the first component forms at least a portion of the exterior surface of the multicomponent fiber and the second component forms at least a portion of the exterior surface of the multicomponent fiber.

Suggested additives include, but are not limited to, ethoxylated siloxanes and hydrocarbons. Ethoxylated hydrocarbons are defined as compounds that contain a one side that is a hydrocarbon (HC) chain linked to another side that is a poly(ethylene oxide) (PEO) chain, where the link between the two sides can be an ether, an ester, an amide, a sulfonamide, a terephthalate or any other suitable coupling group. There can be multiple HC and PEO chains involved. Suggested examples of ethoxylated hydrocarbons include, but are not limited to, poly(ethylene glycol) 600 dioleate, CAS registry number [9005-07-6] such as MAPEG 600 DO. MAPEG 600 DO is a poly(ethylene glycol) that can be obtained from BASF Corporation of Mount Olive, N.J. Another commercially available example of an ethoxylated hydrocarbon is CHROMASIST 188-A. CHROMASIST 188-A is also a PEG 600 DO and can be obtained from Cognis Corporation of Ambler, Pa. Other suggested examples of ethoxylated hydrocarbon surfactants include, but are not limited to, polyethylene glycol (PEG) derivatives of mono or multiple fatty acid or alcohol chains, where the PEG molecular weight ranges from about 200 to about 5000 and where the fatty acid alkyl chain length can vary from about 4 to about 22 carbons. PEG derivatives of synthetic alcohols and acids having alkyl chains longer than 22 carbons are also possible which may or may not include unsaturated bonds.

Ethoxylated siloxanes are defined as compounds containing a polydimethysiloxane (PDMS) backbone on which one or several poly(ethylene oxide) (PEO) chains can be attached to the PDMS backbone. The PEO can be attached to the PDMS backbone via a hydrocarbon spacer (e.g. ethyl group or other), which is then extended by a PEO chain. One suggested example of an ethoxylated siloxane surfactant is, but is not limited to, Siltech MFF-184-SW dimethyl, methyl, hydroxypropyl ethoxylated siloxane that was obtained from Siltech Corporation of Toronto, Canada. Other suggested examples of ethoxylated siloxane surfactants include, but are not limited to, poly[dimethylsiloxane-co-methyl(3-hydroxypropyl)siloxane]-graft-poly(ethylene glycol)methyl ether, such as MASIL® SF 19 from BASF of Gurnee, Ill., DC 193 and DC 5103, both of which are made by Dow Corning of Midland, Mich. Still other ethoxylated siloxane surfactants are described in U.S. Pat. No. 6,300,258 which is hereby incorporated by reference herein in its entirety. Additional materials, which are compatible with and which do not substantially degrade the performance of the particular additive(s), can optionally be added to and extruded with one or more of the polymeric components. As an example, one or more of the individual components of the multicomponent fiber can optionally include additional surfactants, dyes, stabilizers, processing aids, pigments, fragrances, and so forth.

In another desirable embodiment, the present invention provides fibers, nonwoven fabrics and personal care products that include fibers or a nonwoven fabric that has a first wettability at 35° C. and a second wettability at 21° C. such that the second wettability is slower than the first wettability. In a more desirable embodiment, the fibers and the nonwoven fabrics wet out in less than about 10 seconds at 35° C. but do not wet out in less than about 60 seconds at 21° C. In one example, Example C below, the nonwoven fabric comprises bicomponent fibers that include a first component that includes a blend comprising from about 80 to about 99.9 weight percent of a polyethylene resin and from about 0.1 to about 5 weight percent of an ethoxylated hydrocarbon and a second component that includes a blend that includes from about 80 to about 99.9 weight percent of a polypropylene resin and from about 0.1 to about 5 weight percent of an ethoxylated hydrocarbon. Thus, the present invention also provides a nonwoven fabric that may allow for “selected wettability” in a personal care product like a diaper or a training pant. A nonwoven fabric with selected wettability may be used as a liner or a surge management layer or as a component of a liner or a surge management layer to provide a liner or surge management that is highly wettable at body temperature, under no hydrostatic pressure (or non-forced fluid flow), and provides fast intake and fluid distribution at body temperature while providing slower intake at lower temperatures. It is hypothesized that as an insult desorbs into a personal care product the insult begins to cool and as the insult cools the insult will no longer find the liner and/or surge management layer as wettable as the insult initially does on first contact of the insult with the liner and/or surge management layer. Effective capillary attraction of these intake materials, liner and or surge management layers, diminishes with decreasing temperature, thus, compelling fluid to be absorbed by any absorbent material(s) adjacent or otherwise in proximity to these layers. Resulting in an intake system and product that provide for fluid to be driven through these liner and/or surge management layers that are in close contact with the skin increasing the movement of fluid into an absorbent layer below. It is also hypothesized that the temperature dependent wettability of the liner and/or surge management layer will prevent, or at least reduce, rewetting of the liner or surge management, which will more effectively reduce rewetting of the skin of the wearer and may help to keep insult from leaking out of the diaper. Reduced rewetting may reduce Trans Epidermal Water Levels (TEWL) on the skin. Reduced TEWL and reduced leakage are desirable in personal care products.

The fibers may have a denier (g/9000 meters) of less than about 4 and still more desirably less than about 1 and even more desirably less than about 0.5. In a further aspect, the fibers can have an average cross-sectional diameter of less than about 25 micrometers and desirably have an average cross-sectional diameter between about 10 micrometers and about 25 micrometers and still more desirably between about 15 and about 20 micrometers. As used herein, average fiber size is determined using the largest dimension in the fiber cross-section. While fibers are commonly manufactured as solid-round structures it will be appreciated that the multicomponent fibers of the present invention can also have various fiber shapes other than solid-round fibers such as, for example, hollow, multilobal or flat (e.g. ribbon shaped) fibers.

The components forming the fibers can comprise one or more melt-processable polymers. The individual components can comprise the same, similar and/or different polymers. However, at least two of the individual components are distinct in that they have selected and distinct amounts of active agent therein. Fibers and nonwoven fabrics of the present invention can be made from known processable polymers or resins used to form fibers and nonwoven fabrics including, but not limited to, polyolefins (e.g., polypropylene and polyethylene), polycondensates (e.g., polyamides, polyesters, polycarbonates, and polyacrylates), polyols, polydienes, polyurethanes, polyethers, polyacrylates, polyacetals, polyimides, cellulose esters, polystyrenes and so forth. As particular examples, the polymeric components can comprise polyethylene, polypropylene, poly(1-butene), poly(2-butene), poly(1-pentene), poly(2-pentene), poly(1-methyl-1-pentene), poly(3-methyl-1-pentene), and poly(4-methyl-1-pentene) and so forth. Many nonwoven fabrics are made from polyolefins. Suggested polyolefins, include but are not limited to, homopolymers and copolymers of ethylene and homopolymers and copolymers of propylene. In one group of desirable embodiments, the first polyolefin is selected from the group consisting of homopolymers and copolymer of ethylene and the second polyolefin is selected from the group consisting of homopolymers and copolymers of propylene.

It is suggested that at least one component of the fibers include from about 0.1 to about 5 weight percent of an additive or a combination of additives to improve the wettability of the fibers and nonwoven fabrics formed from the fibers. The second component may include from about 0.1 to about 5 weight percent of a second additive or second combination of additives distinct from the first additive or first combination of additives. For example, a first component may contain from about 0.1 to about 5 weight percent of an ethoxylated hydrocarbon or a combination of ethoxylated hydrocarbons and a second component may contain from about 0.1 to about 5 weight percent of an ethoxylated siloxane or a combination of ethoxylated siloxanes. Fibers of the present invention may include a first component that comprises from about 0.5 to about 3 weight percent of an ethoxylated hydrocarbon and a second component that includes from about 0.5 to about 3 weight percent of an ethoxylated siloxane. Desirably, the first component is a substantially homogeneous melt blend comprising a first polyolefin and an ethoxylated hydrocarbon surfactant and the second component is a substantially homogeneous melt blend comprising a second polyolefin and an ethoxylated hydrocarbon surfactant. Methods of blending polymers and various additives are well known and include, but are not limited to, melt blending, co-extrusion via direct addition of additive into the extruder during melt processing, masterbatch methods and so forth. The present invention also provides nonwoven fabrics that include multicomponent fibers that include a first component that comprises a blend of a first polyolefin and from about 0.1 to about 5 weight percent of an ethoxylated hydrocarbon surfactant and a second component that comprises a blend of a second polyolefin and from about 0.1 to about 5 weight percent of an ethoxylated siloxane surfactant. Nonwoven fabrics of the present invention may be made from various known methods of forming nonwoven fabrics including but not limited to, spunbonding and meltblowing processes, particularly methods of forming nonwoven fabrics from bicomponent or other multicomponent fibers. Exemplary methods and apparatus for making multicomponent nonwoven webs are described in U.S. Pat. No. 3,425,091 to Ueda et al., U.S. Pat. No. 3,981,650 to Page, U.S. Pat. No. 5,601,851 to Terakawa et al., U.S. Pat. No. 5,989,004 to Cook, U.S. Pat. No. 5,344,297 to Hills and U.S. Pat. No. 5,382,400 to Pike et al. Additionally nonwoven fabrics of the present invention may be heat treated on one surface to a greater extent than the other surface to produce a nonwoven fabric having a wettability gradient in the z-direction so that one surface of the nonwoven fabric is more wettable than the other surface of the nonwoven fabric.

In certain desirable embodiments, the present invention may provide wettable fibers and wettable nonwoven fabrics that can be made by simplified processes that do not require drying. Drying may negatively impact the aesthetics of the fabric by making it stiffer and may also lower tensile strength, which may ultimately negatively impact the converting process. In certain desirable embodiments, the present invention provides wettable fibers and wettable nonwoven fabrics that can be made by simplified processes that do not contact fibers or nonwoven fabrics with wet chemical treatment baths, sprays or foams that include aqueous solutions containing one or more surfactants. Advantageously, fibers and nonwoven fabrics of certain desirable embodiments of the present invention are instantly wettable as produced and do not require additional processing or treatment to improve their wettability.

In one particularly desirable embodiment, the present invention provides fibers and fabrics that include a synergistic blend of internal melt additives that impart a unique wetting behavior to a nonwoven fabric that exhibits a fast fluid intake and yet is durable to multiple exposures to aqueous fluids. Such fibers and fabrics are useful in a variety of products including, but not limited to personal care products and other absorbent products such as diapers. Thus, in one embodiment the present invention provides a surge management layer adapted for use in a disposable personal care absorbent product, wherein the surge management layer comprises a spunbonded nonwoven fabric that includes bicomponent fibers that comprise a component that includes a polyethylene resin and from about 0.1 to about 5 weight percent of an ethoxylated hydrocarbon and a component that comprises a blend comprising a polypropylene resin and from about 0.1 to about 5 weight percent of an ethoxylated siloxane. Alternatively, the polyethylene containing component can include an ethoxylated siloxane additive and the polypropylene containing component can include an ethoxylated hydrocarbon additive. Thus, in another embodiment the present invention also provides an spunbond/meltblown/spunbond (SMS) laminate adapted for use as an absorbent core wrap in a disposable personal care absorbent product, wherein the SMS core wrap comprises a spunbonded nonwoven (SB) fabric that includes fibers that comprise a component that includes a polyolefin resin and from about 0.1 to about 5 weight percent of a dual additive system comprising from about 0.1 to about 5 of an ethoxylated hydrocarbon and an ethoxylated siloxane in ratios ranging from 1:10 and 10:1 respectively. The meltblown polyolefin layer can also have the same additive composition as the outer SB layers.

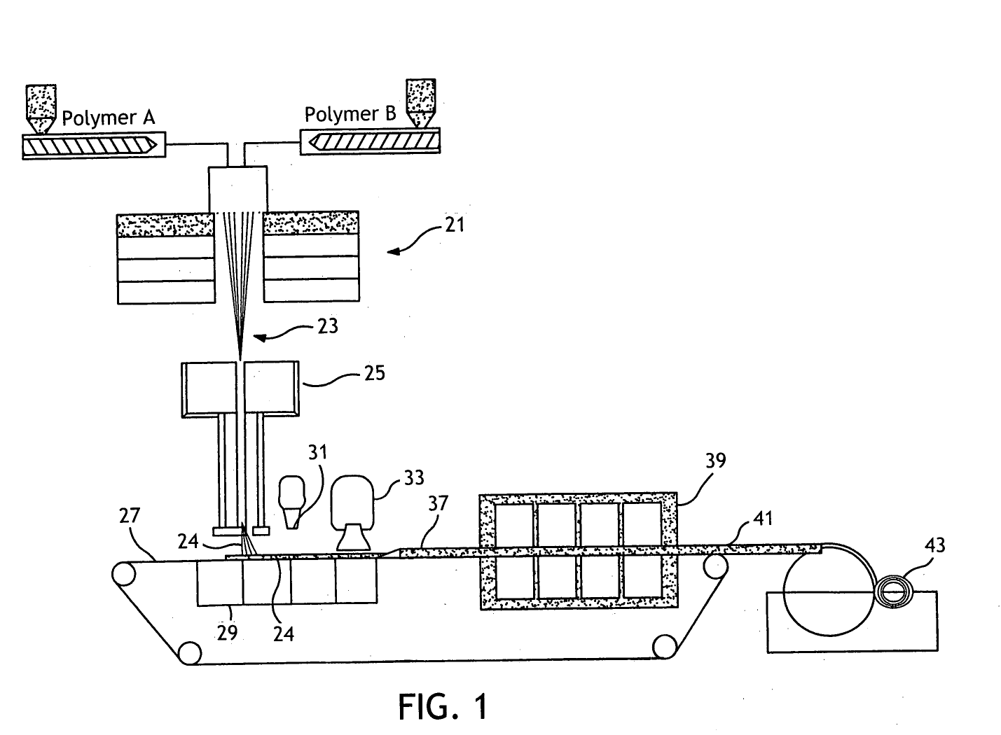

As previously stated, many methods of making nonwoven fabrics are known. Only one advantageous spunbonding method of making a nonwoven fabric is illustrated and described herein. FIG. 1 is a schematic diagram illustrating a desirable method and apparatus for producing high loft, low density nonwoven materials in accordance with one embodiment of the invention by producing crimpable bicomponent side by side substantially continuous fibers. Referring to FIG. 1, a schematic diagram is shown illustrating exemplary methods and apparatus of this invention for producing high loft, low density materials by producing crimpable bicomponent side by side substantially continuous fibers and causing them to crimp in an unrestrained environment. Two polymers A and B are spun with known thermoplastic fiber spinning apparatus 21 to form bicomponent side by side, or A/B, polymer filaments 23. The polymer masses 23 are then traversed through a fiber draw unit (FDU) 25 to form fibers 24. According to one embodiment of the present invention, the FDU is not heated, but is left at ambient temperature (e.g., 65° F.). Thus, while the polymers will be recognized as having been heated to extrude the polymer masses, the actual fibers, as formed in the ambient temperature FDU, will be referred to and understood herein as having been deposited onto a forming surface without the addition of heat to the fibers before deposition. The fibers 24 are left in a substantially continuous state and are deposited on a moving forming wire or surface 27. Deposition of the fibers 24 is aided by an under-wire vacuum supplied by a negative air pressure unit, or below wire exhaust 29.

The fibers 24 are then heated by traversal under one of a hot air knife (HAK) 31 or hot air diffuser 33, which are both shown in the figure but will be appreciated to be used in the alternative under normal circumstances. A conventional hot air knife includes a mandrel with a slot that blows a jet of hot air onto the nonwoven web surface. Such hot air knives are taught, for example, by U.S. Pat. No. 5,707,468 to Arnold, et al. which is incorporated by reference in its entirety. The hot air diffuser 33 is an alternative which operates in a similar manner but with lower air velocity over a greater surface area and thus uses correspondingly lower air temperatures. The group, or layer, of fibers may receive an external skin melting or a small degree of nonfunctional bonding during this traversal through the first heating zone. “Nonfunctionally bonded” is a bonding sufficient only to hold the fibers in place for processing according to the method herein but so light as to not hold the fibers together were they to be manipulated manually. Such bonding may be incidental or eliminated altogether if desirable.

The fibers are then passed out of the first heating zone of the hot air knife 31 or hot air diffuser 33 and may cool. The below wire exhaust 29 may be removed so as to not disrupt crimping. In certain desirable embodiments the nonwoven fabric includes fibers that crimp in the z-direction, or out of the plane of the web, and form a high loft, low density nonwoven web 37. The web 37 is then transported to a through air bonding (TAB) unit 39 to set, or fix, the web at a desired degree of loft and density. Alternatively, the TAB unit 39 can be zoned to provide a first heating zone in place of the hot air knife 31 or hot air diffuser 33, followed by a cooling zone, which is in turn followed by a second heating zone sufficient to fix the web. The fixed web 41 can then be collected on a winding roll 43 or the like for later use.

In accordance with one preferred embodiment of this invention, the substantially continuous fibers are bicomponent fibers. Webs of the present invention may contain a single denier structure (i.e., one fiber size) or a mixed denier structure (i.e., a plurality of fiber sizes). Particularly suitable polymers for forming the structural component of suitable bicomponent fibers include polypropylene and copolymers of propylene and ethylene, and particularly suitable polymers for the adhesive component of the bicomponent fibers includes polyethylene, more particularly linear low density polyethylene, and high density polyethylene. In addition, the adhesive component may contain additives for enhancing the crimpability and/or lowering the bonding temperature of the fibers, as well as enhancing the abrasion resistance, strength and softness of the resulting webs. A particularly suitable bicomponent polyethylene/polypropylene fiber for processing according to the present invention is described in U.S. Pat. No. 5,336,552 to Strack et al. and U.S. Pat. No. 5,382,400 to Pike et al. Webs made according to the present invention may further contain fibers having resins alternative to PP/PE, such as, without limitation: poly(ethylene terephthalate), poly(butylene terephthalate), poly(trimethylene terephthalate), copoly-PP+3% PE, poly(lactic acid), nylon, and so forth. Fibers may be of various alternative shapes and symmetries including pentalobal, tri-T, hollow, striped, cat's eye ribbon, X, Y, H, and asymmetric cross sections.

Polymers useful in the manufacture of the nonwoven materials of the invention may further include thermoplastic polymers like polyolefins, polyesters and polyamides. Elastic polymers may also be used and include block copolymers such as polyurethanes, copolyether esters, polyamide polyether block copolymers, ethylene vinyl acetates, block copolymers having the general formula A-B-A′ or A-B like copoly(styrene/ethylene-butylene), styrene-poly(ethylene-propylene)-styrene, styrene-poly(ethylene-butylene)-styrene, (polystyrene/poly(ethylene-butylene)/polystyrene, poly(styrene/ethylene-butylene/styrene) and the like.

Polyolefins using single site catalysts, sometimes referred to as metallocene catalysts, may also be used. Many polyolefins are available for fiber production, for example polyethylenes such as Dow Chemical's ASPUN7 6811A linear low density polyethylene, 2553 LLDPE and 25355 and 12350 high density polyethylene are such suitable polymers. The polyethylenes have melt indices, respectively, of about 27, 40, 25 and 12 g/10 minutes at conditions of 190° C. and 2.16 kg force. Fiber forming polypropylenes include Exxon Chemical Company's 3155 polypropylene and Montell Chemical Company's PF-304. Many other polyolefins are commercially available.

Biodegradable polymers are also available for fiber production and suitable polymers include poly(lactic acid) (PLA) and a blend of BIONOLLE®, adipic acid and UNITHOX® (BAU). PLA is not a blend but a pure polymer like polypropylene. BAU represents a blend of BIONOLLE®, adipic acid, and UNITHOX® at different percentages. Typically, the blend for staple fiber is 44.1 percent BIONOLLE® 1020, 44.1 percent BIONOLLE® 3020, 9.8 percent adipic acid and 2 percent UNITHOX® 480, though spunbond BAU fibers typically use about 15 percent adipic acid. BIONOLLE® 1020 is polybutylene succinate, BIONOLLE® 3020 is polybutylene succinate adipate copolymer, and UNITHOX® 480 is an ethoxylated alcohol. BIONOLLE® is a trademark of Showa Highpolymer Co. of Japan. UNITHOX® is a trademark of Baker Petrolite which is a subsidiary of Baker Hughes International. It should be noted that these biodegradable polymers are hydrophilic and so are preferably not used for the surface of the inventive intake system materials.

Nonwoven fabrics of the present invention are wettable as made and post-heating of the fabrics may not be necessary to induce wettability of the fabrics to aqueous liquid. However, the fabrics and/or fibers may be heated after forming. For example, the bicomponent fiber may be heated by the HAK 31, hot air diffuser 33 or zoned TAB (not shown) in the first heating zone to a temperature where the polyethylene crystalline regions start to relax their oriented molecular chains and may begin melting. Suggested air temperatures range from about 110-260° F. This temperature range represents temperatures of submelting degree, i.e., above the glass transition temperature (T_{g}) or softening point and below the melting point and may relax the molecular chain up through melting temperatures for the polymers. The heat of the air stream from the HAK 31 may be made higher due to the short dwell time of the fibers through its narrow heating zone. Further, when heat is applied to the oriented molecular chains of the fibers, the molecular chain mobility increases. Rather that being oriented, the chains prefer to relax in a random state. Therefore, the chains bend and fold causing additional shrinkage. Heat to the web may be applied by hot air, IR lamp, microwave or any other heat source that can heat the semi-crystalline regions of the polyethylene to relaxation.

Then the web passes through a cool zone that reduces the temperature of the polymer below its crystallization temperature. Since polyethylene is a semi-crystalline material, the polyethylene chains recrystallize upon cooling causing the polyethylene to shrink. This shrinkage induces a force on one side of the side by side fiber that allows it to crimp or coil if there are no other major forces restricting the fibers from moving freely in any direction. By using the cold FDU, the fibers are constructed so that they do not crimp in a tight helical fashion normal for fibers processed through a normal hot FDU. Instead, the fibers more loosely and randomly crimp, thereby imparting more z-direction loft to the fibers.

Factors that can affect the amount and type of crimp include the dwell time of the web under the heat of the first heating zone. Other factors affecting crimp can include material properties such as fiber denier, polymer type, cross sectional shape and basis weight. Restricting the fibers with either a vacuum, blowing air, or bonding will also affect the amount of crimp and thus the loft, or bulk, desired to be achieved in the high loft, low density webs of the present invention. Therefore, as the fibers enter the cooling zone, no vacuum is applied to hold the fibers to the forming wire 27. Blowing air is likewise controlled or eliminated in the cooling zone to the extent practical or desired.

According to one aspect of the present invention, the fibers may be deposited on the forming wire with a high degree of MD orientation as controlled by the amount of under-wire vacuum, the FDU pressure, and the forming height from the FDU to the wire surface. A high degree of MD orientation may be used to induce very high loft into the web, as further explained below. Further, dependent upon certain fiber and processing parameters, the air jet of the FDU will exhibit a natural frequency which may aid in the producing of certain morphological characteristics such as shingling effects into the loft of the web.

### EXAMPLES

The following Examples were produced by the methods described below and generally illustrated in FIG. 1 with the exception that HAK diffuser 33 was not turned on. Although, the examples presented below are high loft, low density nonwoven webs of but one desirable embodiment, the present invention contemplates nonwoven webs of other multicomponent fibers as well as nonwoven webs having lower lofts and lower densities. The nonowoven webs produced in the Examples had basis weights of about 75 gsm to about 77 gsm (about 2.3 osy), with a bulk of 3.3 mm (about 0.13 inches) and density of 0.023 g/cc. The average denier was measured to be approximately 3.3 dpf (denier per fiber). The fibers were side by side bicomponent, featuring polymer A of Dow 61800.41 polyethylene (PE) and polymer B of Exxon 3155 polypropylene (PP). A TiO₂ additive from the Standridge Color Corporation, of Social Circle, Georgia, tradenamed SCC-4837, was added to the polymer prior to extrusion at 2 percent by weight to provide white color and opacity to the web. The fibers were spun through a 96 hole per inch (hpi) spinpack, spinning in an A/B side by side (s/s) configuration, at a melt temperature of 410° F.

Throughput was balanced in a 50/50 throughput ratio between the two polymers, with a total throughput of 0.7 grams per hole per minute (ghm). The quench air temperature was 55° F. The fiber spin length was 48 inches. The fibers were drawn at 4.0 pounds/square inch/gram (psig) on bank 1, and 4.5 psig on bank 2, using ambient air of, e.g., approximately 65° F. The bottom of the fiber draw unit (FDU) was 12 inches above the forming wire, which was moving at 229 ft/min, as measured on the forming wire. The hot air knife (HAK) was set at 250° F. and 5.0 inches H₂O of pressure on bank 1, and 240° F. and 3.5 inches H₂O on bank 2, at a height of 5.0 inches above the forming wire. The below wire exhaust under the FDU was set to vacuum of approximately 1.6 inches H₂O in bank 1, and 3.8 inches H₂O in bank 2. The web was bonded at approximately 262-269° F. in a through air bonder (TAB). The respective additives that were used in the following examples were precompounded in the base resin by a third party prior to fiber extrusion.

Alternative methods of forming nonwoven fabrics of the present invention will be obvious to those of ordinary skill in the art. Such alternative methods include, but are not limited to, e.g. methods of forming bicomponent fibers and fabrics that do not necessarily have high loft and/or high density as well as other methods of forming multicomponent fibers and fabrics for examples methods that produce multicomponent fibers and/or fabrics that include more than two components. The present invention will now be described with reference to specific examples below.

### Comparative Example A

A nonwoven web was made by using the spunbonding process described above and illustrated in FIG. 1 to produce side by side bicomponent fibers and a nonwoven fabric of the bicomponent fibers. The process is also generally described and illustrated in copending U.S. patent application Ser. No. 10/037,467 and Ser. No. 10/749,805. The bicomponent fibers and nonwoven fabric of this Comparative Example A did not include any internal surfactant additives to increase the wettability of the nonwoven fabric. However, the nonwoven fabric of this Comparative Example A was surface treated with an aqueous, foamed solution that included surfactants to improve the wettability of the nonwoven fabric of the surface of the fabric. The aqueous solution included 2 percent by weight of a 3:1:1 by weight mixture of 3 components: AHCOVEL Base N-62, GLUCOPON 220 UP and MASIL SF-19. AHCOVEL Base N-62 (also referred to simply as “AHCOVEL”) is a blend of a hydrogenated, ethoxylated castor oil and sorbitan monooleate. GLUCOPON 220 UP (also referred to simply as “GLUCOPON”) is a alkyl polyglycoside, specifically and octyl polyglycoside, that is commercially available from Cognis Corporation of Ambler, Pa. And, MASIL SF-19 is an ethoxylated siloxane surfactant, specifically, an ethoxylated trisiloxane, that is available from BASF of Gurnee Ill.

The polypropylene component (A) of the side by side bicomponent fibers consisted of a melt blend of about 98 weight percent of Exxon 3155 polypropylene (PP) resin obtained from ExxonMobil and 2 weight percent of titanium dioxide opacifier. The polyethylene component (B) of the side by side bicomponent fibers consisted of a melt blend of about 98 weight percent of Dow 61800.41 polyethylene (PE) resin and 2 weight percent of titanium dioxide opacifier.

The nonwoven fabric was treated off line with the 2 weight percent 3:1:1 by weight AHCOVEL Base N-62, GLUCOPON 220 UP MASIL SF-19 mixture using the process generally described and illustrated in copending U.S. patent application Ser. No. 10/327,828.

### Example 1

A nonwoven web was made by using the spunbonding process described above and generally illustrated in FIG. 1 to produce bicomponent fibers and a nonwoven fabric of bicomponent fibers. The bicomponent fibers and nonwoven fabric of this Example 1 included an ethoxylated hydrocarbon surfactant in one component and an ethoxylated siloxane surfactant in the other component of the bicomponent fibers. The polypropylene component (A) consisted of a melt blend of about 96 weight percent of Exxon 3155 polypropylene resin obtained from ExxonMobil, 2 weight percent of titanium dioxide opacifier, and about 2 weight percent of MFF 184 SW ethoxylated siloxane obtained from Siltech Corporation of Toronto, Canada. The polyethylene component (B) consisted of a melt blend of about 96 weight percent of Dow 61800.41 polyethylene resin, 2 weight percent of titanium dioxide opacifier and about 2 weight percent of poly(ethylene glycol) 600 dioleate (abbreviated as PEG 600 DO), sold as Chromassist 188-A by Cognis Corporation of Ambler, Pa.

No spinning issues were observed with either of the components during spinning of the bicomponent fibers that included the ethoxylated siloxane and ethoxylated hydrocarbon additives.

### Example B

A nonwoven web of side by side bicomponent fibers for this Example B was made by using the spunbonding process described above except that the polypropylene (A) component consisted of a melt blend of about 96 weight percent of Exxon 3155 polypropylene resin obtained from ExxonMobil, 2 weight percent of titanium dioxide opacifier, and about 2 weight percent of MFF 184 SW ethoxylated siloxane and the polyethylene (B) component consisted of a melt blend of about 96 weight percent of Dow 61800.41 polyethylene resin, 2 weight percent of titanium dioxide opacifier and about 2 weight percent of MFF 184 SW ethoxylated siloxane.

### Example C

A nonwoven web of side by side bicomponent fibers for this Example C was made by using the spunbonding process described above where the polypropylene (A) component consisted of a melt blend of about 96 weight percent of Exxon 3155 polypropylene resin obtained from ExxonMobil, 2 weight percent of titanium dioxide opacifier, and about 2 weight percent of PEG 600 DO and the polyethylene (B) component consisted of a melt blend of about 96 weight percent of Dow 61800.41 polyethylene resin, 2 weight percent of titanium dioxide opacifier and about 2 weight percent of PEG 600 DO.

Example C was also tested for wettability at varying temperatures. Specifically, Example C was tested by placing a sample of fabric of this Example C in a pan of water at approximately 35° C., with no pressure applied (non-forced flow), to determine the wettability of the sample at a temperature that approximates body temperatures (37° C. or 98.6° F.) and similarly placing a second sample of fabric of this Example C in a pan of water at approximately 21° C. to determine the wettability of the sample at room temperature (about 70° F.) with no pressure applied (non-forced flow). The sample was observed to completely wet out at 35° C., usually instantaneously and completely. The term “wetting out” of a fabric is known in the art and describes the condition of the fabric when suspended in water such that the fabric no longer floats on the surface and becomes more transparent as a result of the fibers coming into contact with the water. The sample placed in water at 21° C. did not wet out instantaneously, more specifically, the sample did not wet out within the first minute (60 seconds) at 21° C. and typically did not wet out within the first 2 minutes at 21° C. Thus, this example provides fibers and nonwoven fabrics with a temperature dependent wetting behavior. More specifically, this example provides fibers and nonwoven fabrics that are wettable at body temperatures (about 35 to 37° C. or 95 to 98.6° F.) and that are not as wettable at lower temperatures, for example room temperature or about 21° C. (about 70° F.).

The example also provides a nonwoven fabric that may allow for “selected wettability” in a personal care product like a diaper or a training pant. For example, a nonwoven fabric with selected wettability may be used as a liner or a surge management layer or as a component of a liner or a surge management layer to provide a liner or surge management layer that is highly wettable to fluids leaving the body at body temperature, thus providing fast intake and fluid distribution. However, as the fluid cools in the liner or surge management layer the fluid has less of a tendency to wet the liner or layer, thus providing a better opportunity to be transferred to any underlying absorbent layer(s). This provides less fluid flowback and/or rewet of the skin, thus providing dryer skin.

### Example D

A nonwoven web of side by side bicomponent fibers for this Example D was made by using the spunbonding process described above where the polypropylene (A) component consisted of a melt blend of about 96 weight percent of Exxon 3155 polypropylene resin obtained from ExxonMobil, 2 weight percent of titanium dioxide opacifier, and about 2 weight percent of MFF 184 SW ethoxylated siloxane and the polyethylene (B) component consisted of a melt blend of about 98 weight percent of Dow 61800.41 polyethylene resin and 2 weight percent of titanium dioxide opacifier.

### Example E

A nonwoven web of side by side bicomponent fibers for this Example E was made by using the spunbonding process described above where the polypropylene (A) component consisted of a melt blend of about 97 weight percent of Exxon 3155 polypropylene resin obtained from ExxonMobil, 2 weight percent of titanium dioxide opacifier, and about 1 weight percent of PEG 600 DO and the polyethylene (B) component consisted of a melt blend of about 97 weight percent of Dow 61800.41 polyethylene resin, 2 weight percent of titanium dioxide opacifier and about 1 weight percent of PEG 600 DO.

### Example F

A nonwoven web of side by side bicomponent fibers for this Example F was made by using the spunbonding process described above where the polypropylene (A) component consisted of a melt blend of about 98 weight percent of Exxon 3155 polypropylene resin and 2 weight percent of titanium dioxide opacifier and the polyethylene (B) component consisted of a melt blend of about 96 weight percent of Dow 61800.41 polyethylene resin, about 2 weight percent of titanium dioxide opacifier and about 2 weight percent of PEG 600 DO.

### Example G

A nonwoven web of side by side bicomponent fibers for this Example G was made by using the spunbonding process described above where the polypropylene (A) component consisted of a melt blend of about 96 weight percent of Exxon 3155 polypropylene resin, 2 weight percent of titanium dioxide opacifier and 2 weight percent of MFF 184 SW ethoxylated siloxane and the polyethylene (B) component consisted of a melt blend of about 96 weight percent of Dow 61800.41 polyethylene resin, about 2 weight percent of titanium dioxide opacifier and about 2 weight percent of MFF 184 SW ethoxylated siloxane.

### Example H

A nonwoven web of side by side bicomponent fibers for this Example H was made by using the spunbonding process described above where the polypropylene (A) component consisted of a melt blend of about 97 weight percent of Exxon 3155 polypropylene resin, 2 weight percent of titanium dioxide opacifier and 1 weight percent of MFF 184 SW ethoxylated siloxane and the polyethylene (B) component consisted of a melt blend of about 97 weight percent of Dow 61800.41 polyethylene resin, about 2 weight percent of titanium dioxide opacifier and about 1 weight percent of MFF 184 SW ethoxylated siloxane.

### Example I

A nonwoven web of side by side bicomponent fibers for this Example I was made by using the spunbonding process described above where the polypropylene (A) component consisted of a melt blend of about 98 weight percent of Exxon 3155 polypropylene resin and 2 weight percent of titanium dioxide opacifier and the polyethylene (B) component consisted of a melt blend of about 96 weight percent of Dow 61800.41 polyethylene resin, about 2 weight percent of titanium dioxide opacifier and about 2 weight percent of MFF 184 SW ethoxylated siloxane.

### Example J

A nonwoven web of side by side bicomponent fibers for this Example J was made by using the spunbonding process described above where the polypropylene (A) component consisted of a melt blend of about 98 weight percent of Exxon 3155 polypropylene resin and 2 weight percent of titanium dioxide opacifier and the polyethylene (B) component consisted of a melt blend of about 95 weight percent of Dow 61800.41 polyethylene resin, about 2 weight percent of titanium dioxide opacifier and about 3 weight percent of MFF 184 SW ethoxylated siloxane.

Wetting properties of the bicomponent spunbonded fabrics of the Examples were tested under dynamic fluid (or forced fluid flow) contact conditions, at 25° C., using the EDANA fluid strikethrough test (EDANA 150.1-90), with exception that the test procedure was modified to use 10 milliliters (ml) of saline instead of 5 milliliters for the results presented in Table A below.

TABLE A

| Insult | | | | | | | | | | | |
|---|---|---|---|---|---|---|---|---|---|---|---|
| number | A | 1 | B | C | D | E | F | G | H | I | J |
| 1 | 1.7 | 1.6 | 3.2 | 4.1 | 1.9 | 52.6 | 1.8 | 1.8 | 1.8 | 2.1 | 1.4 |
| 2 | 1.9 | 1.9 | 7.4 | 3.9 | 17.2 | 19.5 | 1.4 | 4.2 | 19.2 | 6.5 | 2.2 |
| 3 | 1.9 | 1.7 | 18.7 | 3.6 | 27.3 | 13.4 | 1.6 | 15.5 | 52.0 | 21.0 | 29.1 |
| 4 | 2.5 | 2.0 | 16.4 | 3.6 | 26.6 | 56.9 | 1.9 | 34.1 | 38.8 | 36.4 | 13.6 |
| 5 | 2.5 | 3.0 | 32.9 | 3.5 | 32.8 | 18.8 | 2.5 | 41.3 | 60.0 | 60.0 | 14.0 |
| 6 | 3.8 | 3.7 | 36.0 | 3.6 | 45.3 | 60.0 | 4.1 | 31.2 | 60.0 | 60.0 | 20.2 |
| 7 | 4.3 | 7.5 | 27.3 | 4.0 | 61.4 | 60.0 | 5.1 | 44.5 | 60.0 | 60.0 | 60.0 |
| 8 | 3.7 | 12.4 | 33.2 | 4.8 | 67.3 | 60.0 | 10.1 | 60.0 | 60.0 | 60.0 | 60.0 |
| 9 | 4.9 | 13.7 | 19.9 | 5.4 | 66.1 | 60.0 | 19.1 | 60.0 | 60.0 | 60.0 | 60.0 |
| 10 | 6.9 | 21.9 | 28.5 | 6.9 | 65.0 | 60.0 | 14.8 | 60.0 | 60.0 | 60.0 | 60.0 |

Those skilled in the art will also see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims. To the extent the following claims use means plus function language, it is not meant to include there, or in the instant specification, anything not structurally equivalent to what is shown in the embodiments disclosed in the specification.

1. A nonwoven fabric comprising multicomponent fibers that comprise
a first component that comprises a blend of a first polymer and from about 0.1 to about 5 weight percent of an ethoxylated hydrocarbon surfactant or a combination of ethoxylated hydrocarbon surfactants and
a second component that comprises a blend of a second polymer and from about 0.1 to about 5 weight percent of an ethoxylated siloxane surfactant or a combination of ethoxylated siloxane surfactants.

2. The nonwoven fabric of claim 1, wherein the first component is a substantially homogeneous melt blend that comprises the first polymer and the ethoxylated hydrocarbon surfactant and the second component is a substantially homogeneous melt blend that comprises the second polymer and the ethoxylated siloxane surfactant.

3. The nonwoven fabric of claim 1, wherein the first polymer and the second polymer are independently selected from the group consisting of polyolefins.

4. The nonwoven fabric of claim 1, wherein the first polymer is selected from the group consisting of homopolymers and copolymer of ethylene and the second polymer is selected from the group consisting of homopolymers and copolymers of propylene.

5. The nonwoven fabric of claim 1, wherein the first component comprises from about 0.5 to about 3 weight percent of an ethoxylated hydrocarbon surfactant.

6. The nonwoven fabric of claim 1, wherein the second component comprises from about 0.5 to about 3 weight percent of an ethoxylated siloxane surfactant.

7. The nonwoven fabric of claim 1, wherein multicomponent fibers are thermoplastic polymer fibers having a cross-section, a length, and a peripheral surface and the first component and the second component are arranged in substantially distinct zones across the fiber cross-section and extend substantially continuously along the length of the fibers such that the first component and the second component each have exposed portions forming the outer surface of the multicomponent fibers and further wherein each component forms at least about 25 percent of the outer surface of the multicomponent fibers.

8. A multicomponent fiber comprising
a first component that comprises a blend of a first polyolefin and from about 0.1 to about 5 weight percent of an ethoxylated hydrocarbon or a combination of ethoxylated hydrocarbons and
a second component that comprises a blend of a second polyolefin and from about 0.1 to about 5 weight percent of an ethoxylated siloxane or a combination of ethoxylated siloxanes,
wherein the first component forms at least a portion of the exterior surface of the multicomponent fiber and the second component forms at least a portion of the exterior surface of the multicomponent fiber.

9. The multicomponent fiber of claim 8, wherein the multicomponent fiber is a bicomponent fiber.

10. The multicomponent fiber of claim 9, wherein the first component and the second component are in a side by side configuration.

11. The multicomponent fiber of claim 8, wherein the ethoxylated siloxane is or comprises poly[dimethylsiloxane-co-methyl(3-hydroxypropyl)siloxane]-graft-poly(ethylene glycol)methyl ether.

12. The multicomponent fiber of claim 8, wherein the ethoxylated hydrocarbon is or comprises poly(ethylene glycol) 600 dioleate.

13. The multicomponent fiber of claim 8, wherein the first polyolefin and the second polyolefin are selected from the group consisting of homopolymers and copolymers of ethylene and homopolymers and copolymers of propylene.

14. The multicomponent fiber of claim 8, wherein the first polyolefin is selected from the group consisting of homopolymers and copolymer of ethylene and the second polyolefin is selected from the group consisting of homopolymers and copolymers of propylene.

15. The multicomponent fiber of claim 8, wherein the first component comprises from about 0.5 to about 3 weight percent of the ethoxylated hydrocarbon or combination of ethoxylated hydrocarbon and the second component comprises from about 0.5 to about 3 weight percent of the ethoxylated siloxane or combination of ethoxylated siloxanes.

16. A surge management layer adapted for use in a disposable personal care absorbent product, the surge management layer comprising
a spunbond nonwoven fabric, the spunbond nonwoven fabric comprising bicomponent fibers that comprise
a first component that comprises a blend comprising from about 80 to about 99.9 weight percent of a polyethylene resin and from about 0.1 to about 5 weight percent of an ethoxylated hydrocarbon or a combination of ethoxylated hydrocarbons and
a second component that comprises a blend comprising from about 80 to about 99.9 weight percent of a polypropylene resin and from about 0.1 to about 5 weight percent of an ethoxylated siloxane or a combination of ethoxylated siloxanes,
wherein the first component and the second component are in a side by side configuration.

17. The surge management layer of claim 16, wherein multicomponent fibers have a cross-section, a length, and a peripheral surface wherein the first component and the second component are arranged in substantially distinct zones across the fiber cross-sections and extend substantially continuously along the length of the fibers and the first component and the second component each have exposed portions forming an outer surface of the multicomponent fibers so that the each component forms at least about 40 percent of the outer surface of the multicomponent fibers.

18. A personal care product comprising a nonwoven fabric that has a first wettability at 35° C. and a second wettability at 21° C. wherein the second wettability is slower than the first wettability.

19. The personal care product of claim 18 wherein the nonwoven fabric wets out in less than about 10 seconds at 21° C. and does in less than about 60 seconds at 35° C.

20. The personal care product of claim 18 wherein the nonwoven fabric comprises bicomponent fibers that comprise
a first component that comprises a blend comprising from about 80 to about 99.9 weight percent of a polyethylene resin and from about 0.1 to about 5 weight percent of an ethoxylated hydrocarbon and
a second component that comprises a blend comprising from about 80 to about 99.9 weight percent of a polypropylene resin and from about 0.1 to about 5 weight percent of an ethoxylated hydrocarbon.
